(19) United States
(12) Patent Application Publication
(10) Pub. No.: US 2003/0069858 A1
(43) Pub. Date: Apr. 10, 2003

(54) Transaction processing system in a distributed network

(76) Inventors: Kenneth Kittlitz, Calgary (CA); David McFadzean, Montreal (CA); Justin LaFrance, Calgary (CA)

Correspondence Address: THOMAS E. MALYSZKO, SUITE 1500, 250 - 6 AVENUE, S.W., CALGARY, T2P 3H7, CA

(21) Appl. No.: 10/191,972

(22) Filed: Jul. 10, 2002

Related U.S. Application Data
(60) Provisional application No. 60/304,620, filed on Jul. 10, 2001.

(51) Int. Cl. G06F 17/60

(52) U.S. Cl. 705/76

(57) ABSTRACT

A system for processing transactions in a distributed network is disclosed. In the system, various parties interact by means of client subsystems that allow them to use public key cryptography to digitally sign and verify messages. The parties send these messages to each others' client subsystems and to a transaction server, which carries out financial transactions on behalf of the parties. All financial transactions generate receipts signed by the transaction server and the initiating party, creating a secure and fraud-resistant audit trail. The integrity of the system can be verified on a continuous and ongoing basis by examining the receipts that result from transfers. The risk of fraud arising from deposits and withdrawals between the system and external sources is mitigated by isolating such transactions. Parties in the system may generate digitally signed offers specifying financial payments and/or non-financial terms and conditions that may be accepted by other parties in the system. The system's distributed nature and isolation of third-party payment handling fees make small financial transactions economically viable.

### CROSS REFERENCE TO RELATED APPLICATION

This application claims benefit of priority under 35 U.S.C. 119(e) of U.S. Provisional Application No. 60/304,620, filed Jul. 10, 2001 and entitled “TRANSACTION PROCESSING SYSTEM IN A DISTRIBUTED NETWORK” by LaFrance et. al., which is incorporated by reference in its entirety.

### FIELD OF THE INVENTION

The present invention generally relates to a method and apparatus for processing transactions in a distributed network, and in particular relates to a system and method for processing financial transactions and contracts securely and in real-time on the Internet.

### BACKGROUND OF THE INVENTION

The Internet is a vast collection of computers and other devices interconnected so that information can be exchanged amongst them using a variety of protocols and standards. Most familiarly, computers and devices on the Internet use the Hypertext Transfer Protocol (HTTP) to locate and retrieve information. This protocol is used, for example, by web browser applications such as Microsoft's Internet Explorer “web browser” to retrieve data from other computers on the Internet.

Protocols such as HTTP were not designed to support the processing of financial transactions, or indeed, any transaction that involves a contract between two or more parties. However, electronic commerce has become an increasingly important part of the Internet over the past decade, resulting in ad hoc solutions to the problem.

One widespread approach is the use of credit cards to facilitate online commerce. Credit card information is entered by the consumer either to purchase an individual item, or the consumer enters this information after using “shopping cart” software to aggregate a number of items they wish to purchase. However, this method is subject to several disadvantages:

The merchant is subject to risk if the credit card information was used fraudulently (e.g., if the card information was stolen);

The consumer must enter card information for each purchase, unless the merchant's computer records and stores this information or it is stored on the consumer's computer. If the information is so recorded, then the consumer and/or merchant are at risk if the computer is compromised and the information stolen;

The economics of credit card transactions (i.e., fees charged by the credit card companies) mean that transactions of less than approximately 3.00 USD are not viable;

Person-to-person payments and non-monetary transactions are not supported by this method; and,

The merchant does not receive the consumer's funds in real-time.

Alternative payment systems such as PayPal (HTTP address: http://www.paypal.com) avoid some of the above disadvantages. In a PayPal-like system, individuals may deposit money into an account via credit card or electronic funds transfer. They can then transfer funds to other persons, including merchants, by specifying the recipient's electronic mail address using a web browser interface. The actual transaction is carried out on the PayPal server machines. Though allowing person-to-person transactions, and avoiding the need to enter payment information for every transaction, PayPal-like systems have the following shortcomings:

Non-monetary transactions are not supported;

The purchaser of a good or service does not receive a receipt that can be used to prove purchase or, if the good was digital, re-obtain it at a later date; and,

The structure and economics of the system mean that small-priced transactions are not viable.

A method more suited to small transactions is Millicent (HTTP address: http://www.millicent.com). Millicent is designed to support the purchase of digital content such as images, music files, etc. on merchant web-sites. To accomplish this, a system and apparatus known as “digital cash” is purchased by the consumer by means of credit card, bank transfer, etc. This digital cash is effectively a form of currency that can be exchanged with a merchant-specific currency in order to purchase digital content. As such, the system suffers from the following disadvantages:

Vendors do not receive funds in real-time; and,

All the currencies in the system are decoupled from “real world” currencies, meaning that it is possible (though not trivial) to forge money by duplicating or fraudulently creating instances of the “digital cash” currency. This imposes a severe financial risk to both Millicent and vendors using its system.

What is therefore desired is a novel system and method that avoids the deficiencies of the above-noted prior art systems. In particular, the novel system and method should have the following features:

Both monetary and non-monetary transaction should be supported;

For monetary transactions, settlement should be in real-time;

Very low cost monetary transactions should be economically viable;

Parties to a transaction should be protected from fraud; and,

The overall integrity of the system should be verifiable on a continual basis.

### SUMMARY OF THE PRESENT INVENTION

A system and method by which transactions, financial and otherwise, are carried securely and in real-time in a distributed system such as the Internet is disclosed.

According to the present invention, there is provided in one aspect a means by which a funds transfer from one party to one or more other parties is carried out. The transfer request is cryptographically signed by the source party using its private key, and specifies the identities of the party or parties to whom funds should be transferred. This request is processed by a transaction server, which verifies the cryptographic signature by obtaining the source party's public key from a key server. The transaction server than carries out the funds transfers to all target parties, and issues cryptographically-signed receipts to all parties involved.

In another aspect the invention provides a means by which any party known to the transaction system can issue a cryptographically-signed “offer”, consisting of terms and conditions, which may or may not include funds transfers. The party who receives the offer may accept it by adding their cryptographic signature to it; if funds transfers are required to accept the offer, the newly-signed offer is sent to the transaction server, which carries out the transfers and returns signed receipt(s) to the purchasing party.

In yet another aspect the invention provides a system by which digital content may be obtained by the acceptance of an offer as described above. The party desiring to obtain the content that is subject to the offer accepts the offer and presents the resulting signed offer and/or transfer receipt(s) signed by the transaction server to the party making the offer. The party making the offer validates the signature(s), and provides the content to the requesting party if all signatures are valid.

In yet another aspect the invention provides a system and method by which deposits and withdrawals to and from the transaction server are conducted such that any transaction involving such an external mechanism (for example, deposit from credit card, withdrawal via check) is represented within the transaction server so that the aggregate balance of all accounts within the server is, at all times, exactly equal to zero (0).

In yet another aspect the invention provides a system and method by which the integrity of the transacton server may be validated in real-time and on a perpetual basis. This is accomplished by verifying the signatures of all transactions which have taken place in the server, and confirming that their aggregate balance is zero (0).

### BRIEF DESCRIPTION OF THE DRAWING FIGURES

Embodiments of the invention will now be described, by way of example only, with reference to the accompanying drawings, wherein:

FIG. 1 is an overview of a transaction processing system according to a preferred embodiment of the present invention;

FIG. 2 shows the structure of an account as stored in a client subsystem;

FIG. 3 shows the structure of the key server;

FIG. 4 shows the process by which a key/UID pair is added to the key server;

FIG. 5 shows the structure of the transaction server;

FIG. 6 shows the process by which the transaction server validates incoming requests;

FIG. 7 shows the process by which a new account is created in the system;

FIG. 8 shows the structure of a receipt;

FIG. 9 shows the structure of a transfer request;

FIG. 10 shows the process by which a transfer request is handled by the transaction server;

FIG. 11 shows the structure of an offer;

FIG. 12 demonstrates uses of offers within the system;

FIG. 13 shows the process by which an offer is accepted or rejected;

FIG. 14 shows the process by which an accepted offer is verified;

FIG. 15 shows the process by which funds are deposited into the system; and,

FIG. 16 outlines a computer system suitable for embodying the invention.

### DESCRIPTION OF PREFERRED EMBODIMENTS

The following description is provided to enable a person skilled in the art to make and use the invention and sets forth the best modes contemplated by the inventor for carrying out the invention. Various modifications, however, will remain readily apparent to those skilled in the art, since the basic principles of the present invention have been defined herein specifically to provide a system and method by which transactions can be carried out securely and in real-time in a distributed network.

The preferred embodiment of each aspect of the invention is now described in detail. Examples of the preferred embodiments are illustrated in the accompanying drawings. While the invention will be described in conjunction with preferred embodiments, it will be understood that it is not intended to limit the invention to these preferred embodiments. To the contrary, it is intended to cover alternatives, modifications, and equivalents as may be included within the spirit and scope of the invention as defined by the claims.

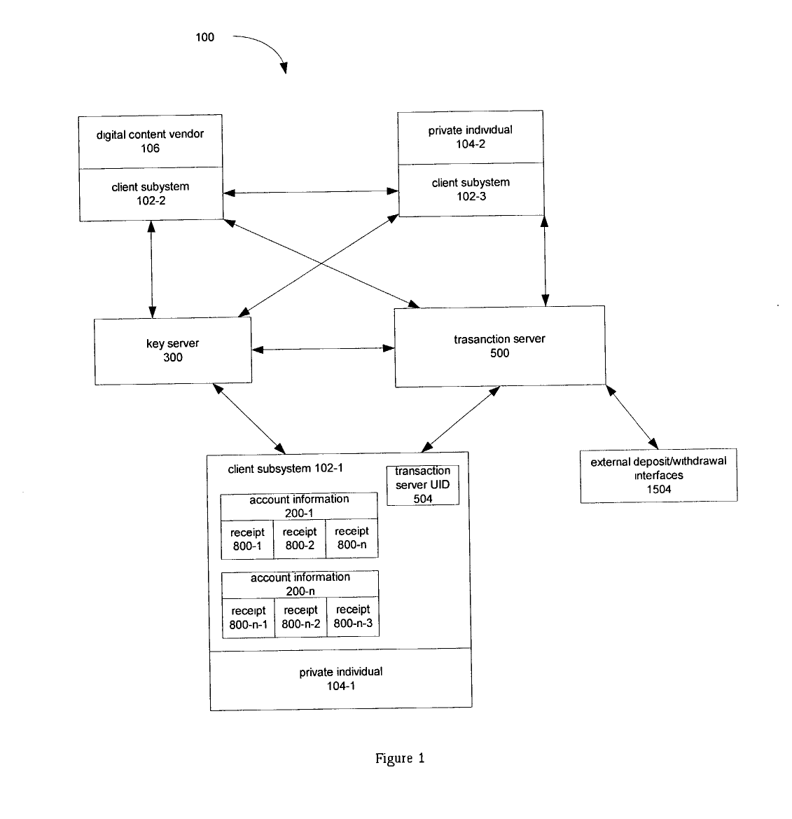

Broadly speaking, an apparatus, system and method of processing transactions in a distributed network are disclosed. An overview of a preferred embodiment is shown in FIG. 1. In this figure, parties such as private individuals (104) or digital content vendors (106) interact by means of a client subsystem (102), which contains information about the party's accounts (200-1 to 200-n) and past transactions (800-1 to 800-n). Note that there may be more than one account stored on a particular client subsystem, as indicated by account 200-n in the drawing. The client subsystem is a piece of software that can be embodied in many ways. For example, it may be embodied as a software program running directly on the party's computer. Alternately, it may run on another computer with which the party communicates by a mechanism such a web browser that uses HTTP (Hypertext Transport Protocol). Through their client subsystems, the parties may interact by communicating with a transaction server (500), responsible for actually carrying out transactions, and a key server (400), which allows parties and components in the system to verify the authorship and integrity of messages sent by other parties and components. Additionally, the transaction server communicates with an external deposit/withdrawal interfaces (1504) to transfer funds to and from the system as a whole.

It should be noted that the components of the system may be part of a distributed network such as the Internet, and accessed via their unique Uniform Resource Locators (URLs). Alternately, they may be located using a system and method such as the “Data Web Object Host Discovery System” as disclosed in U.S. patent application Ser. No. 09/840,848 filed on Apr. 23, 2001 (McFadzean et al.). However, the invention is not limited to such particular means of locating resources and communicating with them; other such mechanisms may be readily apparent to those skilled in the art.

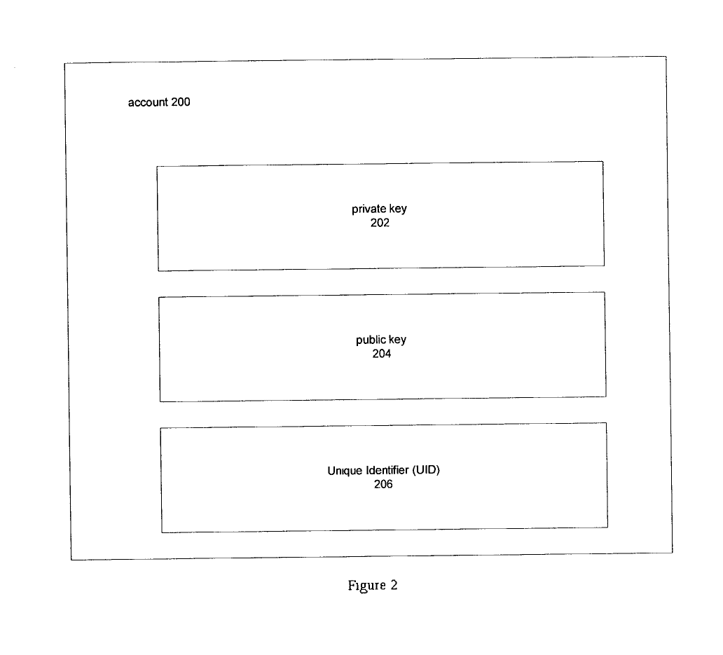

The components illustrated in FIG. 1 are now described in detail through illustrative examples. A party wishing to participate in transactions first creates an account (200). As shown in FIG. 2, an account consists of the following:

A public/private cryptographic key pair, (202 and 204) generated using well-known public key cryptography algorithms (e.g., Schneier, B. “Applied Cryptography, 2^{nd} edition.”, 1995); and,

A unique identifier, or UID, (206) generated by creating a cryptographic hash of the public key, using well-known algorithms such as those discussed in Schneier (ibid.);

A brief summary of the features of public key cryptography that this invention makes use of follows. A private key is known only to the party that created it, and is not shared with any other party. As discussed below, the corresponding public key is made available to other parties. With its private key, a party can create a “digital signature” (also known as “cryptographic signature”) for any piece of data. Other parties may then use the first party's public key to verify this signature. In particular, they can determine whether the first party's private key was really used to create the signature, and they can determine if the data has been altered in any way. Creating the unique ID (UID) of the account from a cryptographic hash of the public key means that any party can verify whether a particular UID corresponds to a particular public key.

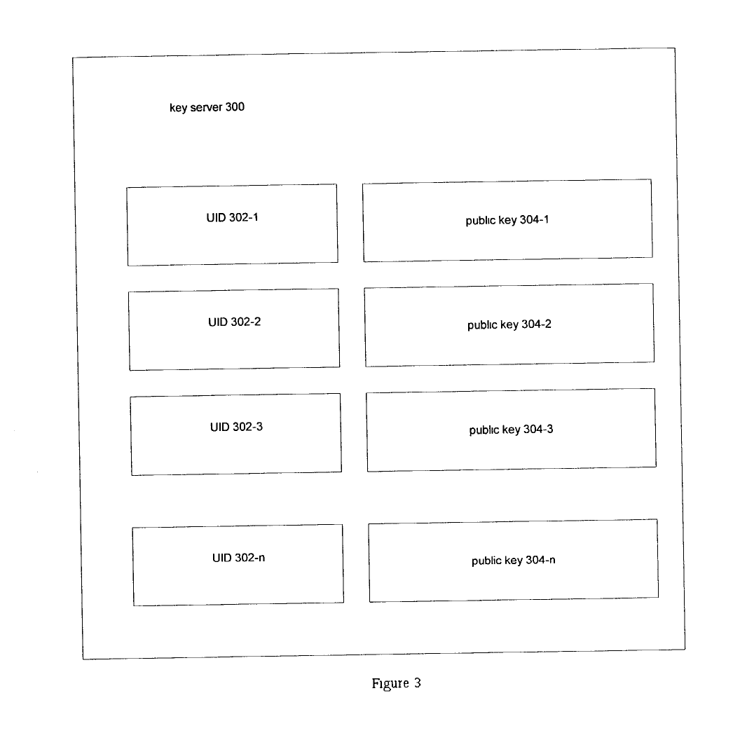

After generating its public/private key pair and UID using its client subsystem, the party submits the public key and UID to a key server. As shown in FIG. 3, a key server may simply consist of a series of UIDs (302-1 to 302-n) and their corresponding public keys (304-1 to 304-n). The key server services requests for public keys, where each request contains a single UID. It returns the public key that corresponds to that UID, or an error message if no match is found.

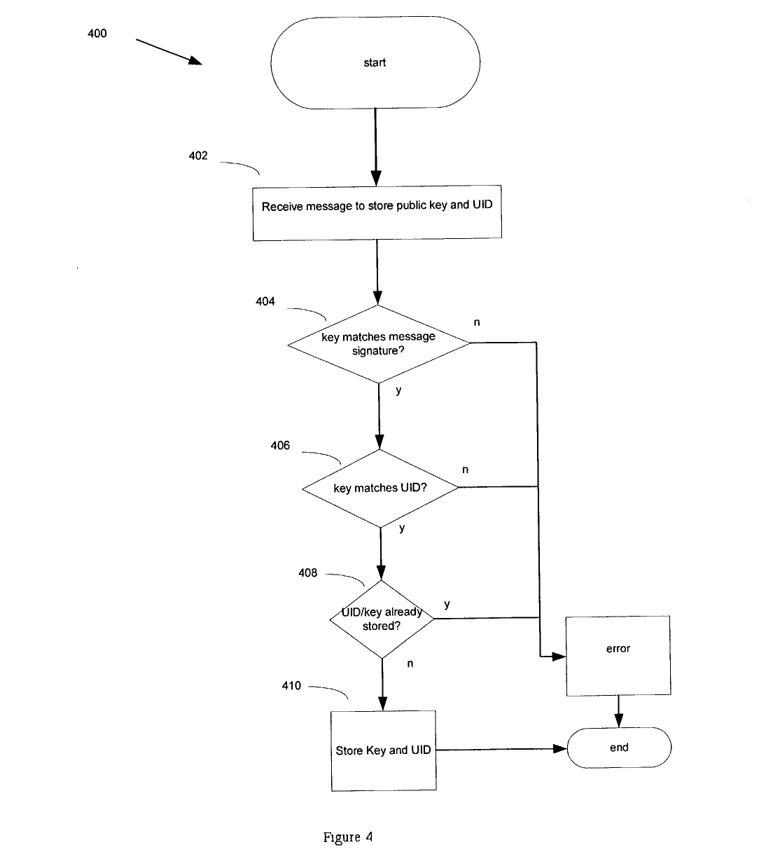

The party wishing to create an account uses its client subsystem to create a digitally-signed message consisting of its public key and UID, and transmits this message to the key server. The key server examines the message using the algorithm shown in FIG. 4. It first verifies that the message was signed by the public key contained in the message at 404. It then verifies at 406 that the UID contained in the message can be obtained from the public key via a cryptographic hashing operation. At 408, it then ensures that the key and UID are not already stored. If all the preceding checks succeed, the key server stores the key and UID at 410 and transmits a status indicating success back to the issuing party. Otherwise, it returns an error status notification.

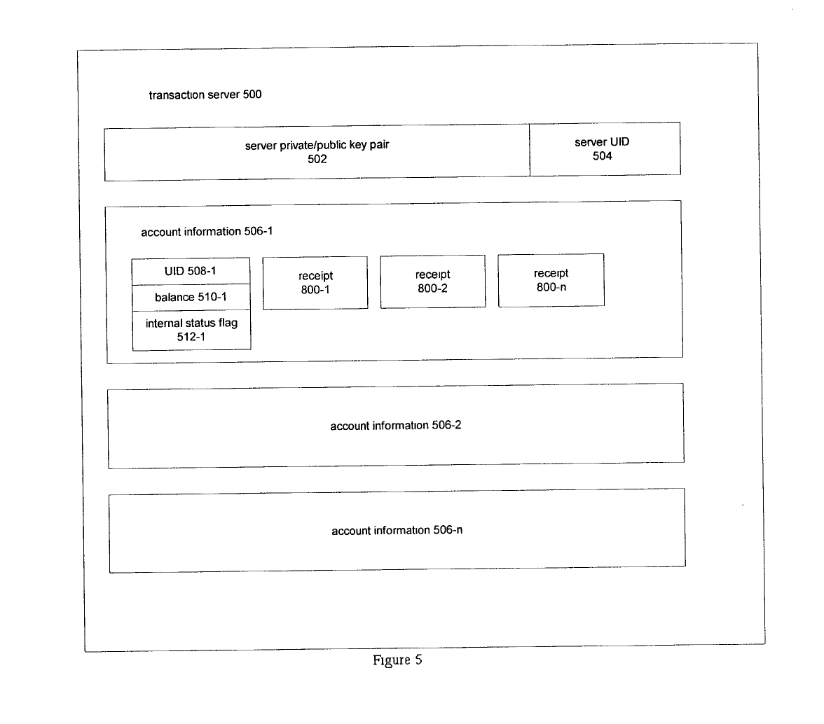

Once the party has successfully registered its public key with the key server, it then sends an account creation request to the transaction server. As depicted in FIG. 5 the transaction server stores a number of different types of data. A public/private key pair (502) belongs to the transaction server itself, and allows it to digitally-sign messages. A UID (504) is generated from the public key as described above, and allows the server to itself be a party to transactions. The UID of the transaction server is assumed to be known to the client subsystems (102). The public key of the transaction server is registered with the key server and thus may be obtained by any party knowing the UID.

The transaction server also contains account information (506-1 to 506-n) for all parties that have accounts in the system. Each account consists of:

a UID (508), which always corresponds to a UID (206) in a client subsystem (102) belonging to some party in the system;

a balance (510), representing the cash balance of the account. One possible embodiment of the balance would be a sixty-four bit integer, representing the balance in tenths of cents USD. For example, a balance of 5000 would correspond to 5.00 USD;

a flag (512) indicating if the account is internal or not. As discussed below, internal accounts, and only internal accounts, may have balances of less than zero; and,

a series of receipts (800-1 to 800-n) that describe all the transaction that the account has been involved in. These receipts are identical to those maintained by the matching client subsystem (102), and are sent to the client subsystem as result of the appropriate request (as discussed below).

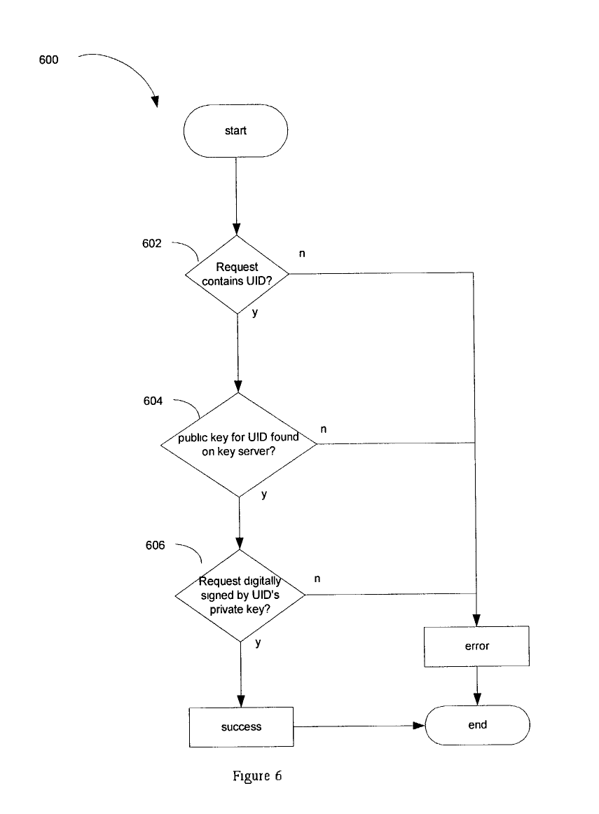

When the transaction server receives a request for a client subsystem, it performs the algorithm shown in FIG. 6 to verify the request. The algorithm ensures at 502 that the request contains a UID, that the appropriate public key can be found for the UID that made the request at 604, and that the request has been properly digitally-signed by the private key corresponding the UID and public key at 606.

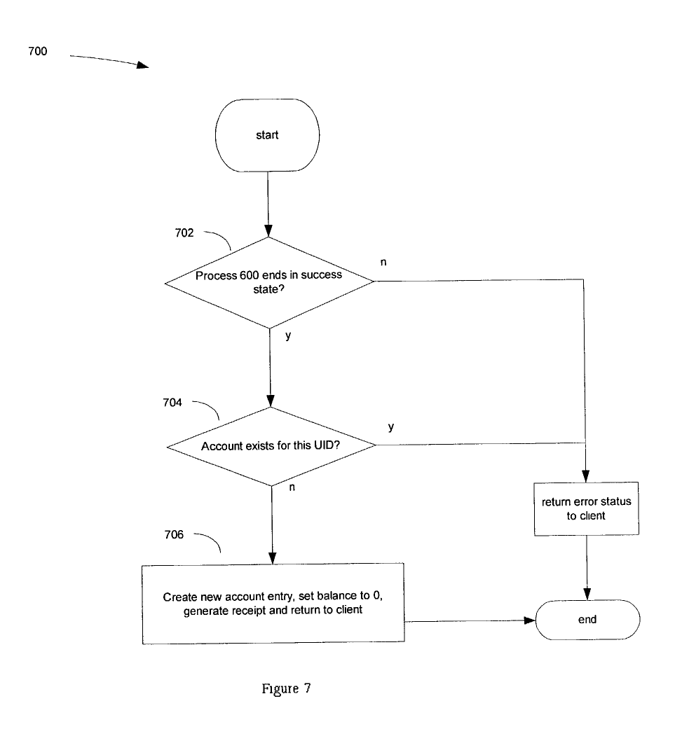

Turning back to the account creation example, when the transaction server receives a request from a client subsystem to create a new account, it performs the algorithm shown in FIG. 7. This algorithm validates the request at 702, ensures that an account does not already exist for the requesting UID in the transaction server at 704, and creates the new account information. The account balance is initialized to zero. Finally, the server creates a digitally-signed receipt at 706 acknowledging the account creation, stores this with the account, and returns it to the client subsystem that originated the request. The client subsystem then stores the receipt.

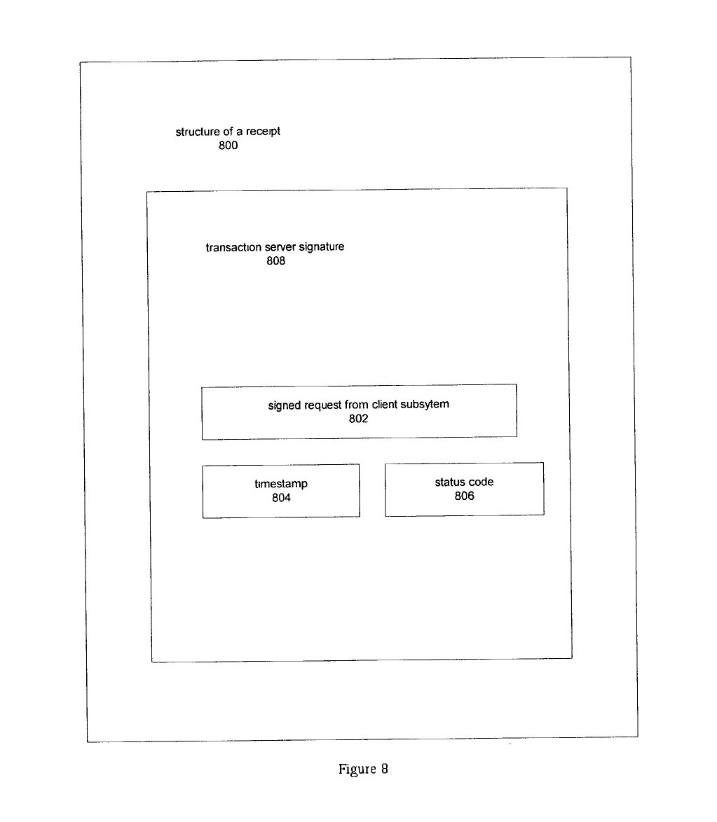

The general structure of a receipt is shown in FIG. 8. In this embodiment, every receipt contains the following:

The signed request (802) from a client subsystem which caused the receipt to be created;

A timestamp (804), with millisecond resolution;

A status code (806), which indicates success or the type of error that occurred will processing the client subsystem request; and,

The signature of the transaction server (808), which applies to the entire receipt.

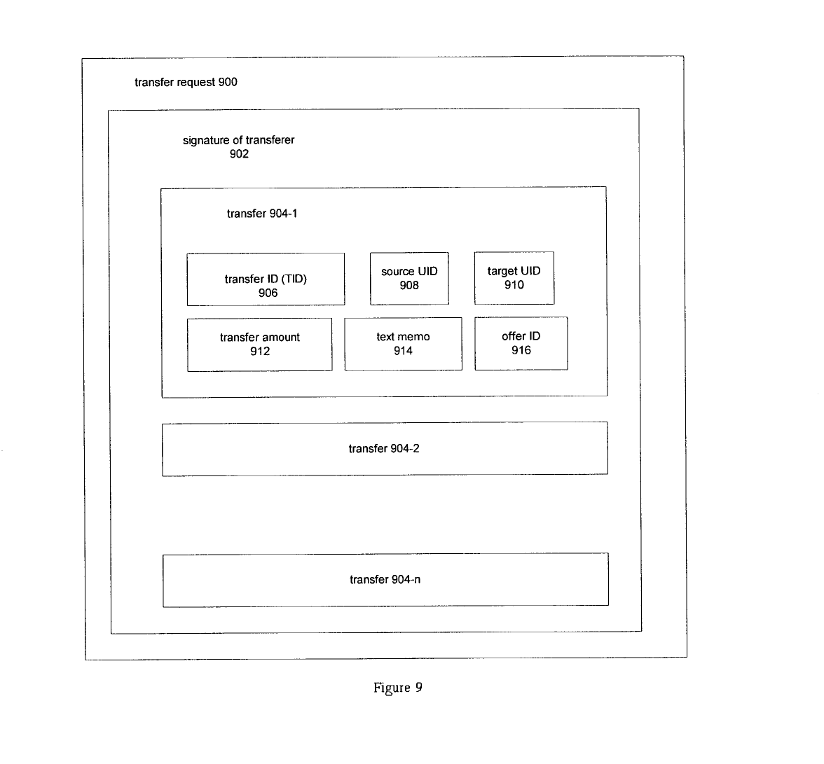

The above discussion discloses how a new account is created within a system embodied by the invention. Leaving aside for the moment the question of how funds enter and leave the system, we now turn to how financial transaction are carried out within the system. FIG. 9 shows the general structure of a transfer request. Like a request to create a new account, a transfer request (900) is signed by the private key of an account on the client system from which it originates (902). It contains one or more individual transfers (904) consisting of:

A transfer identifier, or TID (906), that is globally unique. Such globally unique identifiers can be generated, for example, by creating a cryptographic hash from a string of ASCII characters consisting of the source UID, the target UID, the transfer amount, and the time at which the transfer is made;

The UID of the source of the transfer (908);

The UID of the recipient, or target (910), of the transfer;

The amount of the transfer (912), in the denomination and currency used by the transaction server;

An optional text memo field (914) describing the transfer; and,

An optional offer ID (916), discussed in more detail below.

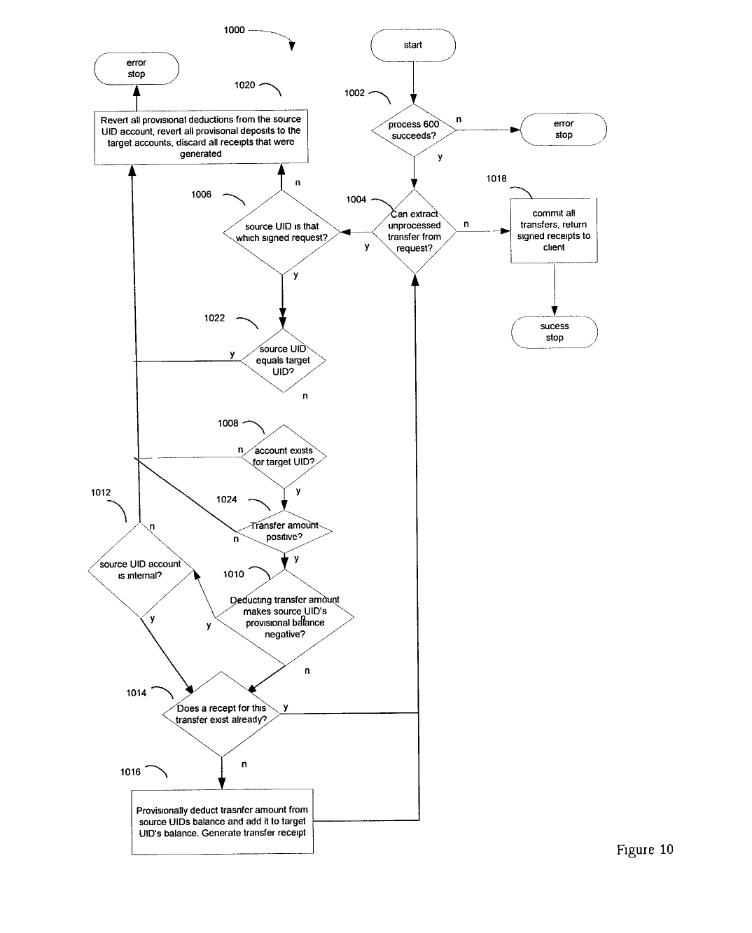

When the transaction server receives a transfer request, it performs the process flow charted in FIG. 10. After validating the request, it examines each transfer in the request, verifying that the source UID is the same as that which signed the request at 1006, that the source and target UIDs differ at 1022, that the target UID corresponds to an existing account at 1008, and that the transfer amount is positive at 1024. It then checks if a deduction of the transfer amount from the source UID's account would cause a negative balance (1010); this is acceptable if the source account is flagged as being an internal account (1012). If all checks pass, the process determines if a receipt already exists for this transfer by seeing if a transfer with that TID is already stored on the server (1014). As discussed below, this may be the case if the transfer is in response to an offer. Otherwise, a new receipt is generated.

If all transfers can be successfully processed, the process actually carries out the adjustment in balances of the source UID and the target UID(s), signs all newly-generated receipts, and returns the receipts to the client subsystem (1018). If an error is encountered processing any transfer, all provisional balance adjustments are reverted, all generated receipts are discarded and an error status is returned to the client (1020).

Thus, the result of a successful transfer request is not only a change in the respective balances of the source and target UID accounts, but the creation of transfer receipts signed by the transaction server that include the original signed transfer request from the source UID. This method has a number of advantages over the prior art:

The auditability of the system is greatly enhanced, as will be discussed further below;

Issues of fraud (for example, on the part of either buyer or seller in a commercial transaction) become easier to resolve, because transfer requests are signed by the originating party, and successful transfers are counter-signed by a trusted party (the transaction server); and,

Once a transfer has been made to satisfy an offer (as discussed further below), the existing receipt can be retrieved from the transaction server (or from the source UID's client subsystem) to satisfy that offer again in the future. For example, this allows a person to retrieve digital content they have already paid for at a later date.

Another advantage is that settlement is in real-time (i.e., once the funds transfer has taken place, the recipient may spend the transfer amount immediately).

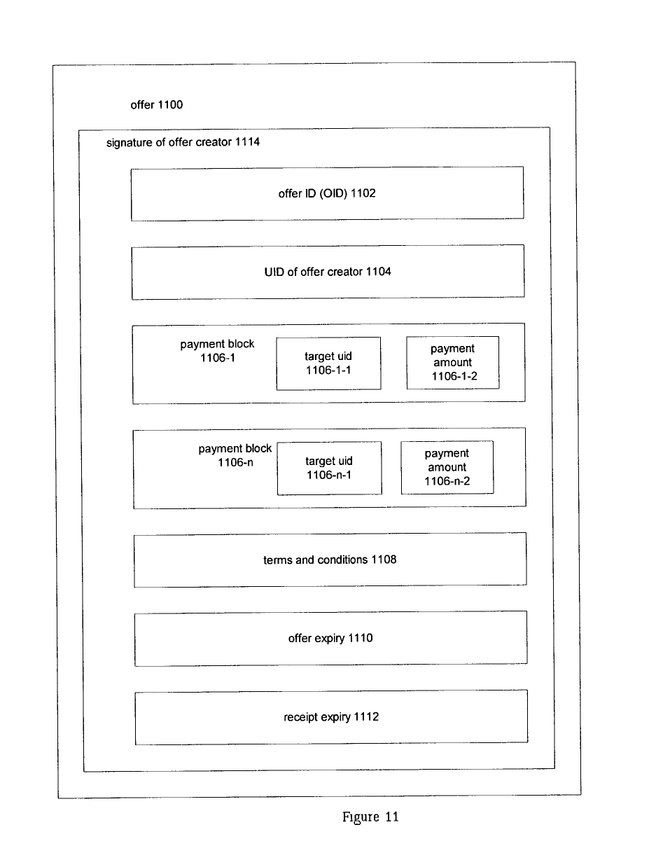

We now turn to how transactions such as purchases and contracts can be embodied using the system. FIG. 11 shows the structure of an “offer”, a piece of data that contains the following:

A unique Offer ID, or OID (1102). Such a unique identifier can be generated, for example, using the GUID (Globally Unique Identifier) algorithm developed for the CORBA architecture (see http://www.omg.org);

The UID of the party creating the offer (1104);

Zero or more payment blocks (1106-1 to 1106-n), with each block containing the UID of the target of the payment, and the payment amount;

An optional terms section (1108), which describes the terms of the offer in human-readable form;

An optional offer expiry time (1110), which denotes when the offer expires; and,

An optional receipt expiry time offset (1112), which denotes how long from time of purchase a receipt for the offer remains valid.

The entire offer is digitally-signed by the account that created it (1114). Note that at least one payment block, or a non-empty terms section, must appear in the offer.

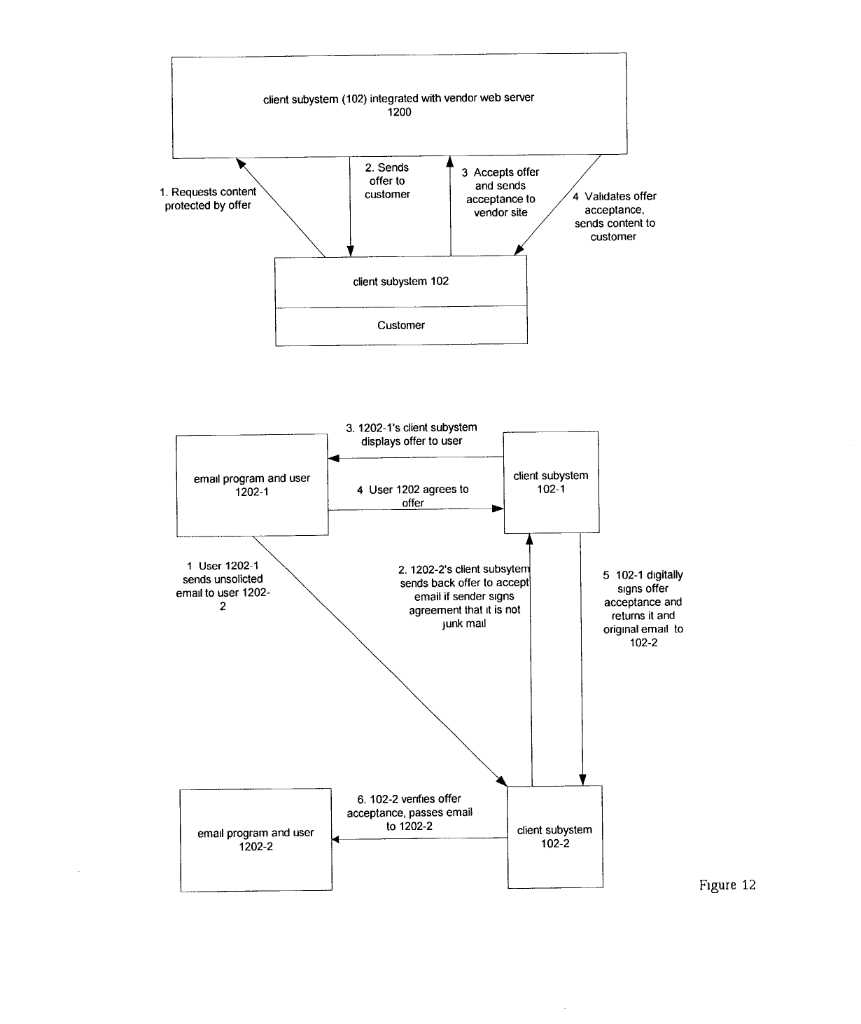

FIG. 12 shows two examples of how offers may be used. In the first, a content vendor uses offers to “protect” digital content on his/her web-site. This can be done by having a client subsystem interact with the vendor's web server to ensure that content is released only when the request is accompanied by the proper offer acceptance. The process for determining this is as follows. The customer submits a request for content in step 1. In step 2, the vendor's client subsystem intercepts the request and returns an offer associated with the content. In step 3, the customer's client subsystem obtains the customer's acceptance of the offer, and carries out the offer acceptance using a process described below. In step 4, the vendor's client subsystem validates the offer acceptance, and sends the content protected by the offer to the customer.

In the second example in FIG. 12, two email programs are integrated with client subsystems. The user of email program 1202-1 sends an email to the user of email program 1202-2 (step 1). The email is intercepted by the second user's client subsystem 102-2 which determines that it is unsolicited (for example, the sender's address may not appear in 1202-2's list of known correspondents). Client subsystem 102-2 therefore generates an offer in step 2, stating that the user of email program 1202-2 will accept the email if the sender asserts that it is not junk mail. This offer is received by client subsystem 102-1, which presents to the user of email program 1202-1 in step 3. In step 4, the user accepts the offer, and client subsystem 102-1 generates the offer acceptance message, digitally signing it with the private key belong to the user in step 5. When the client subsystem 102-2 receives this acceptance, it validates it and passes the accompanying email on to the email program 1202-2 (step 6).

The above examples demonstrate that the transaction processing system has a very flexible notion of what a transaction is. Although the first example in FIG. 12 would likely involve a funds transfer (between the customer and merchant), the second example did not. However, the second example did result in a digitally-signed message sent from one party to another stating that their email was not junk mail; if this statement proves to be false, the second party may be able to claim violation of contract. The flexibility of the invention's notion of what a transaction is, and its ability to let people create and accept contracts using digital signatures, is an advantage over prior art transaction processing systems.

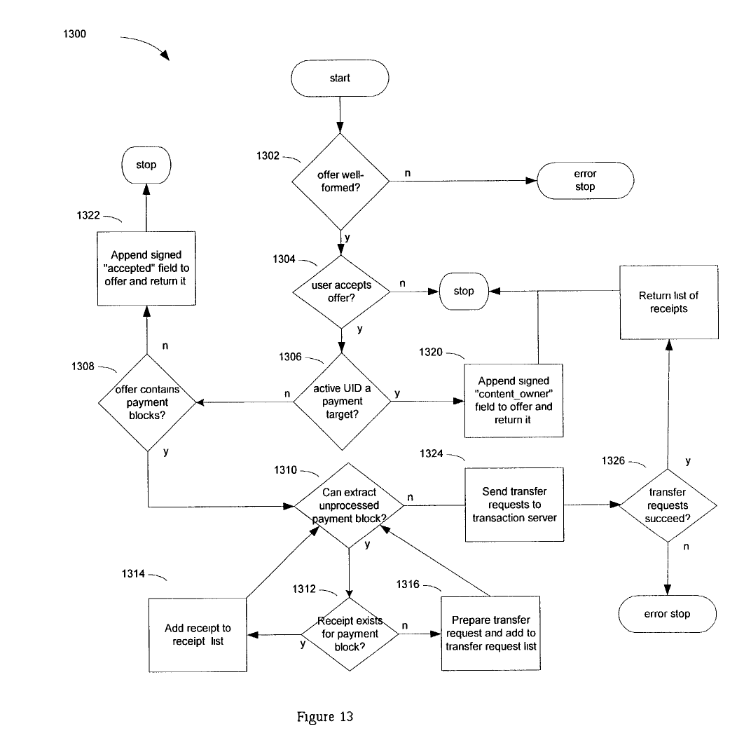

The flow chart illustrated in FIG. 13 shows how an offer is processed. First, the offer is checked to see if it properly signed, using a process similar to that discussed previously and shown in FIG. 6. At 1304, the client subsystem determines if the user wishes to accept the offer. In one embodiment, this could be done by presenting a dialog box to the user showing the offer details and letting them specify whether they accept or decline. If the user accepts, a check is made at 1306 to see if the user's currently-active account UID is one of the payment targets of the offer. If so, the subsystem appends a field “content_owner” to the offer, containing the account's public key, signs it with the account private key, and returns the result to the originator of the offer at 1320. This allows, for example, the owners of digital content to view it without having to make fund transfers.

The client subsystem then checks at 1308 if payment blocks are present in the offer. If not, it appends an “accepted” field to the offer, containing the user account's public key, signs it with the account private key and returns the result to the offer originator (1320). Otherwise, it continues to extract unprocessed payment blocks from the offer at 1310 until none remains. For each payment block, it determines if a valid receipt is available for the payment (1312). This is determined as follows:

1. A TID for the transfer is obtained by performing a cryptographic hash on an ASCII string consisting of the payment target, payment amount and offer ID; and,

2. If a receipt is found in the client subsystem matching that TID, the subsystem compares the time the receipt was obtained against the current time and the receipt expiry as contained in the offer. If the receipt has not expired, it is valid.

Valid receipts are added to a list at 1314. If no valid receipt is available, the subsystem prepares a transfer request, with the TID constructed as described above, and adds it to another list at 1316. Once all payment blocks have been processed, the subsystem signs the list of transfer requests and submits them to the transaction server at 1324. If all transfers succeed, the subsystem returns all receipts to the originator of the offer.

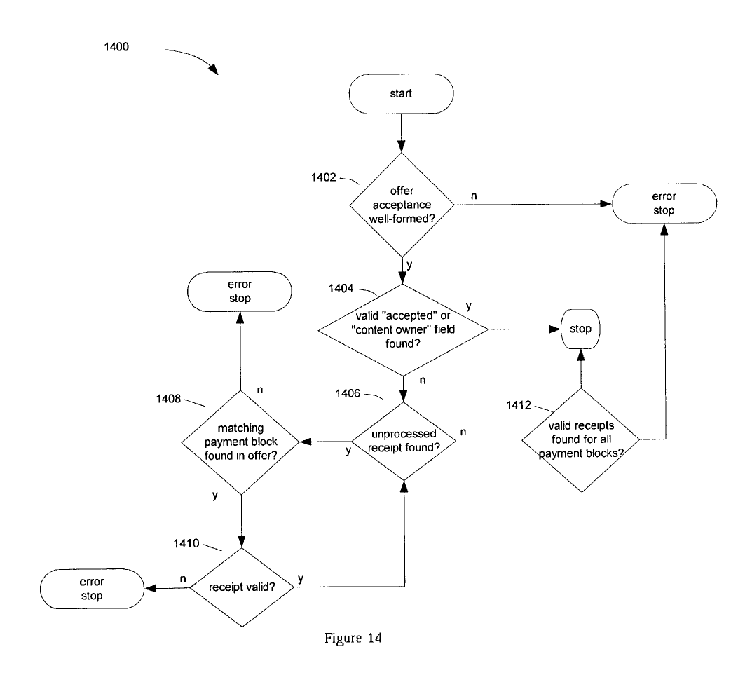

The counterpart to this, namely validating an offer acceptance, is shown in FIG. 14. At 1402, the process determines if the offer acceptance is well-formed by verifying the signature against the public key of the UID that claimed to sign it. It then checks at 1404 if the acceptance is actually the original offer with a signed “content_owner” or “accepted” field appended it to it. If so, it verifies the signature and determines whether the public key contained in the field actually belongs to the UID that signed the field by querying the key server. In the case of the “content_owner” field, it also verifies that the signing UID is the target of a payment in the offer.

If the offer acceptance consists of a list of transfer receipts, the process check that the target of each receipt corresponds to a target in one of the offer payment blocks (1408). It further verifies each receipt (1410), by checking:

that the receipt is signed by the UID that accepted the offer;

that the receipt is signed by the transaction server;

that the receipt contains the offer ID of a non-expired offer; and,

that the receipt itself has not expired.

Note that the offer ID must be the same in all receipts. If all receipts are valid, the process checks at 1412 that all payment blocks in the offer have been accounted for. In the above process, what happens on a successful stop condition depends on the context of the offer. For example, the illustrations in FIG. 12 showed two different purposes a successful offer acceptance could be put to.

We now discuss how funds enter and leave the system. Transaction server accounts flagged as “internal” have balances that are the negatives of “real world” bank accounts. For example, if a real world account used to hold credit card deposits has a balance of $10,000, the corresponding internal account would have a balance of minus $10,000. One internal account exists for each real world bank account used as a means of getting funds in and out of the system. It should be noted that ordinary accounts cannot be created as internal accounts; the flagging of an account as internal can only be done by an operator with administrative rights on the transaction server.

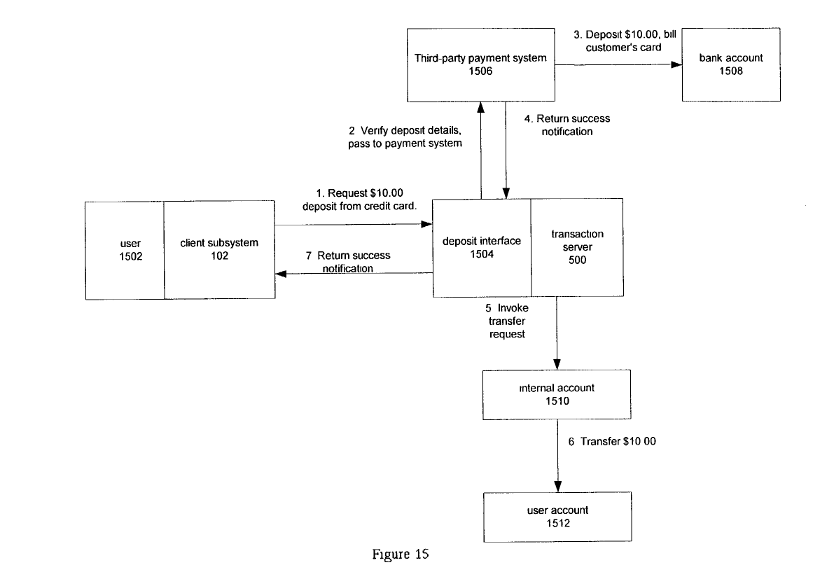

FIG. 15 illustrates how a deposit would be carried out. The user 1502 uses her client subsystem to interact with a deposit interface 1504 supported by the transaction server. The deposit interface is assumed to provide an Application Programming Interface (API) which the transaction server can use to communicate with a third-party payment system to carry out and verify the real-world deposit.

In step 1, the user submits a deposit request for $10.00. Included with this request is the UID of the user's account, which may be provided automatically by the client subsystem. The deposit interface verifies that the UID belongs to an existing account, the carries out the transaction by communicating with the third-party payment system (steps 2 and 3). After being notified of the transaction's success in step 4, the transaction server prepares a transfer request from the corresponding internal account to the user's account in step 5. This transfer is carried out in step 6, and has the effect of making the internal account's balance $10.00 more negative, and the user account balance $10.00 more positive. Notification of success is returned to the user in step 7.

Withdrawals are analogous. To withdraw money, the user makes a transfer request to the internal account corresponding to the desired withdrawal method. For example, if $50.00 is to be withdrawn via money order, the user's account would transfer that amount to the money order internal account. From there, the transaction server interacts with the appropriate third-party payment system to cause the withdrawal to be completed.

Most third-party payment systems charge handling-fees. These can be added automatically to the desired deposit or withdrawal amount. For example, in the $10.00 deposit described above, $10.50 may actually be billed to the user's credit card, the $0.50 representing handling fees that do not appear either in the user's transaction server account nor in the corresponding real world bank account.

The above method of interacting with real-world payment processors has a number of advantages of prior art systems:

an “audit trail”, consisting of signed transfer requests, is created automatically for every deposit or withdrawal;

once money is in the transaction processing system, users of the system are protected from risks such as credit card fraud; and,

because any handling fees are charged “up front”, very small transactions are economically viable within the system.

Another important aspect of the invention is its auditability. The structure of the transaction server makes auditing straightforward. To completely audit the system up to a timestamp, t, the following algorithm is used:

1. For each account, retrieve its receipts having timestamps up to time t;

2. For each receipt, verify the following:

all required fields exist;

the digital signature is valid and belongs the account;

the amount is greater than 0;

the target UID exists in the database; and,

a corresponding receipt (one with the same amount and timestamp) exists in the target UID's account;

3. As each receipt is processed, add its amount to two balances, the first representing that account balance, the second representing the aggregate system balance;

4. If the account balance ever drops below 0, and the account is not flagged as being an internal account, report an error condition;

5. After all receipts for an account have been processed, verify that the computed account balance is equal to that stored for the account; and,

6. After all accounts have been processed, verify that the aggregate system balance is exactly 0.

The test done in step 6 holds because for every unit of money in the system, there is a corresponding negative unit of money in an internal account used to deposit funds into the system.

If all verifications succeed, the integrity of the system has been verified up to time t. An error condition can be reported if any step in the verification fails, and could, for example, automatically halt the transaction server and alert a human operator. The audit process can run continuously, and provides a degree of security and integrity not present in prior art systems.

It should be appreciated that the distributed nature of the invention facilitates low cost transactions. In particular, the distributed nature of the client subsystems that allow parties to use public key cryptography spreads the computational cost of the cryptographic operations over the many computers and other devices that comprise the system, meaning that small transactions are economically feasible.

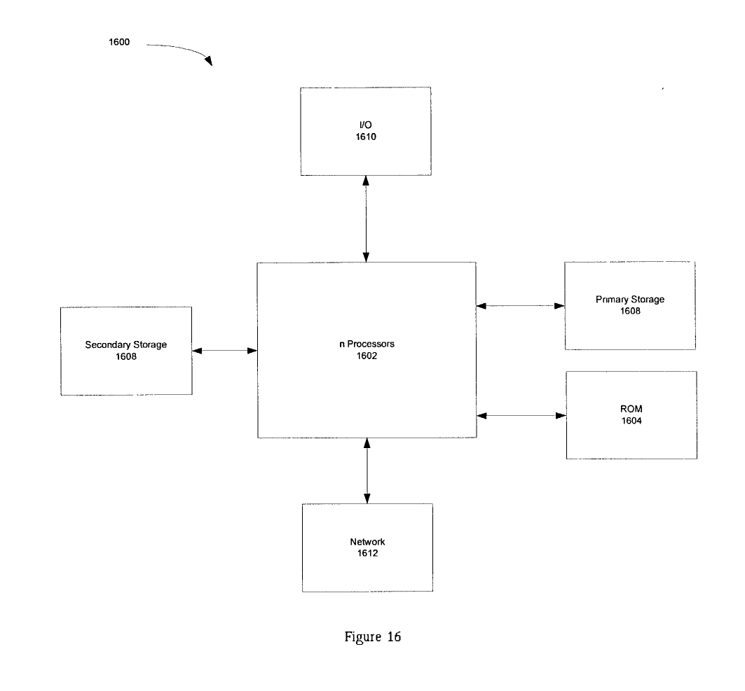

FIG. 16 illustrates a computer system 1600 that can be employed to implement the present invention. The computer system 1600 or, more specifically, CPUs 1602, may be arranged to support a virtual machine, as will be appreciated by those skilled in the art. As is well known in the art, ROM acts to transfer data and instructions unidirectionally to the CPUs 1602, while RAM is used typically to transfer data and instructions in a bi-directional manner. CPUs 1602 may generally include any number of processors. Both primary storage devices 1604, 1606 may include any suitable computer-readable media. A secondary storage medium 1608, which is typically a mass memory device, is also coupled bi-directionally to CPUs 1602 and provides additional data storage capacity. The mass memory device 1608 is a storage medium such as a hard disk or tape which is generally slower than primary storage devices 1604, 1606. Mass memory storage device 1608 may take the form of a magnetic or paper tape reader or some other well-known device. It will be appreciated that the information retained within the mass memory device 1608, may, in appropriate cases, be incorporated in standard fashion as part of RAM 1606 as virtual memory. A specific primary storage device 1604 such as a CD-ROM may also pass data unidirectionally to the CPUs 1602.

CPUs 1602 are also coupled to one or more input/output devices that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 1602 may optionally be coupled to a computer or telecommunications network, e.g., an Internet network or an intranet network, using a network connection. With such a network connection, it is contemplated that CPUs 1602 might receive information from the network, or might output information to the network in the course of performing the above-described method steps. Such information, which is often represented as a sequence of instructions to be executed using CPUs 1602, may be received from and outputted to the network, for example, in the form of a computer data signal embodied in a carrier wave. The above-described devices and materials will be familiar to those of skill in the computer hardware and software arts.

Although only a few embodiments of the present invention have been described, it should be understood that the present invention may be embodied in many other specific forms without departing from the spirit or the scope of the present invention.

Although the methods of providing efficient techniques for processing transactions in a distributed network in accordance with the present invention are suitable for implementation with personal computers, digital assistants, and the like, the methods may generally be applied in any suitable low bandwidth or high bandwidth distributed network. In particular, the methods are suitable for use in digital appliances and other low bandwidth networks. Such low bandwidth systems include, but are not limited to: virtual private networks, direct serial communications across telephone lines (“BBS systems”) and LAN and WANs regardless of network protocol.

While the present invention has been described as being used with a computer system coupled to the Internet, it should be appreciated that the present invention may generally be implemented on any suitable computer system. Therefore, the present examples are to be considered as illustrative and not restrictive, and the invention is not to be limited to the details given herein, but may be modified within the scope of the claims along with their full scope of equivalents.

We claim:

1. A computer based system for processing transactions in a distributed network comprising:
various parties interacting by means of client subsystems that allow them to use public key cryptography to digitally sign and verify messages; and,
the parties sending these messages to each others' client subsystems and to a transaction server, which carries out financial transactions on behalf of the parties,
wherein all financial transactions generate receipts signed by the transaction server and the initiating party, creating a secure and fraud-resistant audit trail.
